(19) United States
(12) Patent Application Publication
(10) Pub. No.: US 2012/0103882 A1
(43) Pub. Date: May 3, 2012

(54) Device for Clarifying Wastewater Preferably on Ships

(75) Inventor: Knud Hamann, Appel (DE)

(73) Assignee: HAMANN AG, Hollenstedt (DE)

(21) Appl. No.: 13/266,345

(22) PCT Filed: Apr. 19, 2010
(86) PCT No.: PCT/EP10/02386

§ 371 Date: Dec. 28, 2011

(30) Foreign Application Priority Data
Apr. 29, 2009 (DE) 10 2009 019 428.2

(51) Int. Cl. B01D 35/02

(52) U.S. Cl. 210/150

(57) ABSTRACT

A device for clarifying wastewater, preferably on ships, having the following features: A tank for untreated water is connected to a pressure tank via a macerator and a feed pump. The pressure tank is connected to a compressed air source so that the untreated water in the pressure tank is saturated with air. The pressure tank is connected via a line to a decompression tank in which the flotate and clarification water can be separated from each other. An expansion valve is inserted in the line, and a dosing pump for flocculant is connected to the line between expansion valve and decompression tank.

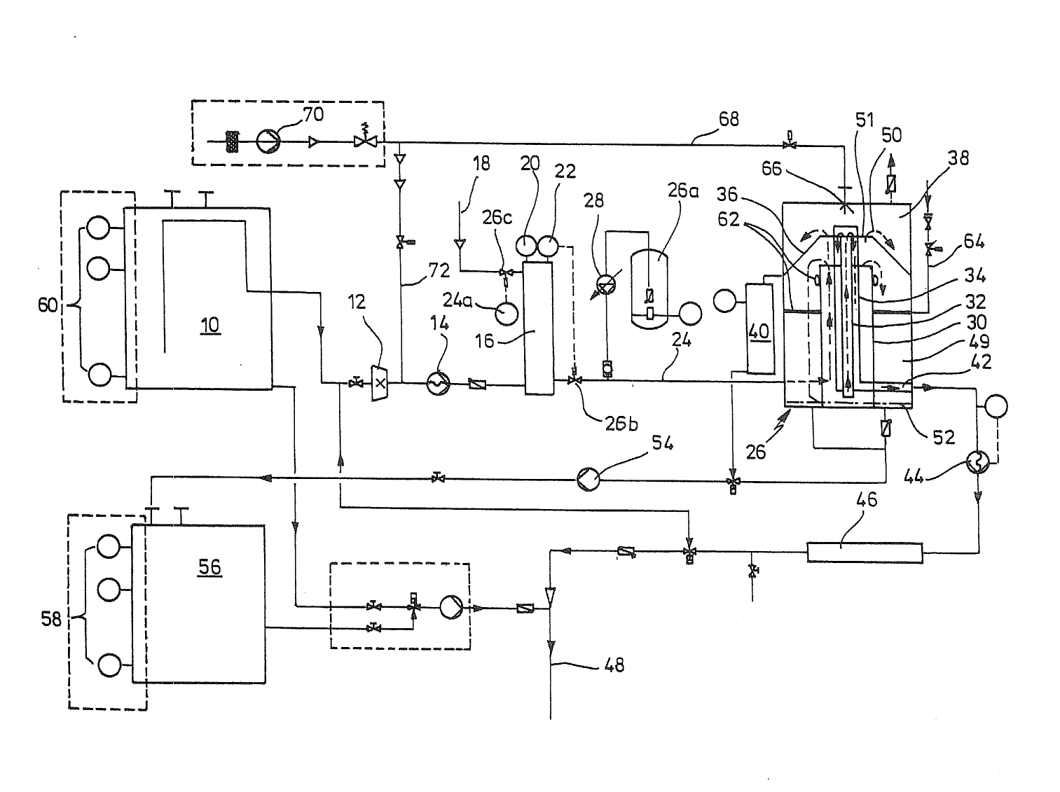

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a device for clarifying wastewater, preferably on ships.

In the clarification of industrial and municipal wastewater and the clarification of untreated water that arises on ships, it is known to use so-called flotation, especially pressure-release flotation. Pressure-release flotation is a separation process in which a gas dissolved under pressure in water outgases upon the reduction of pressure (decompression) and attaches to floating solid particles as it rises, enabling them to float. In pressure-release floatation, wastewater, or a partial flow of clarification water, is generally saturated with air at an overpressure of 4 to 6 bar and then conducted through the decompression fittings into a flotation basin. After decompression to atmospheric pressure, the excess air is released in the form of fine bubbles. In the contact and mixing zone with the solid particles, the gas bubbles form an agglomerate with the solids that, due to its low density, rises to the surface of the basin where it can be removed. The mixture of gas bubbles and solids is termed a flotate to which additional chemical substances (flocculants) are frequently added to achieve a better bond of the solids to the gas bubbles.

So-called microflotation has also become known in which air is introduced into a clarification phase, especially using a multiphase mixing pump. A partial flow of wastewater is added to an air/water mixture. The difference from the aforementioned pressure-release flotation is the smaller size of the air bubbles (microbubbles with a diameter of 30 to 50 μm).

### BRIEF SUMMARY OF THE INVENTION

The object of the invention is to create a device for clarifying wastewater, preferably on ships, in which a very slight amount of equipment is necessary while simultaneously reducing the solid components in the clarification water. In addition, the device should be easy to use.

With the device according to the invention, a tank for untreated water is connected via a macerator and a feed pump to a pressure tank. The pressure tank is connected to a compressed air source so that the untreated water is saturated with air in the pressure tank. The compressed air tank is connected via a line to a decompression tank in which flotate and clarification water are separated from each other. An expansion valve is inserted in the line, and a reservoir for flocculant is connected to the line via a dosing pump between the expansion valve and decompression tank.

With the help of the device according to the invention, the solid content is reduced in the clear water. An extensive separation technique that for example works with membranes, as is the case in the prior art, is not necessary. The device according to the invention requires a small construction volume which is highly advantageous, especially for use on ships. The device according to the invention is user-friendly and reduces the freight of organic and pathogenic components in the clear water.

The decompression tank can be designed in a conventional manner to cause a separation of the flotate and clarification water. One particular embodiement of the invention provides arranging an outer pipe in the decompression tank that ends in the line, preferably in the bottom area. An inner pipe is arranged in the outer pipe and is connected at the bottom end to the area between the decompression tank and outer pipe. It extends upward beyond the outer pipe. A middle pipe extends upward between the inner and outer pipe above the inner pipe in connection with a flotate collection chamber, and the middle pipe is connected to a clarification water pump in the bottom area. The cited tubular, preferably coaxially arranged tanks are communicating pipes that, when their diameters and lengths are suitably dimensioned relative to each other, permit a large slope in relation to the verticals within which functioning is maintained. The height of the inner pipe determines the height of the liquid level in the outer tank and hence the level of the floating flotate.

The untreated water enriched with air rises inside the outer pipe, and the clarification water flows downward in the area between the outer pipe and tank where it then enters the inner pipe from below. The described forced guidance of the air/water mixture ensures that an optimum rise time for the air bubbles is achieved. The flotate floats in the top region of the tank and is pressed upward via a preferably central opening into a flotate collection chamber. The clarification water flows downward in the overflow from the top end of the inner pipe into the gap between the inner pipe and middle pipe where it is drawn off from time to time with the aid of a pump. It is then conducted over board, preferably after UV irradiation. The flotate floats from the flotate collection chamber in the tank into a preferably lower lying flotate collection chamber. The latter is preferably connected to a line in which a sludge pump is arranged. The sludge pump also draws solids from the bottom region of the decompression tank that collect there during the described operation.

The clarification water pump is driven intermittently and is preferably controlled by the pressure in the feedline. The feed pump is operated continuously as long as untreated water is in the untreated water tank.

According to another embodiment of the invention, at least one ring main connected to a compressed air source is arranged in the decompression tank and is provided with a series of openings. Two ring mains are preferably provided that are arranged at different heights. Air from the ring mains bubbles up in the decompression tank, whereby the flotate layer is simultaneously lifted and conveyed via an overflow into the flotate collection tank. This in turn is connected to a sludge collection tank.

A fixed-bed reactor is preferably arranged in the tank on the outside of the outer pipe. Its naturally large surface serves to absorb organic substances that cannot be separated by means of the described the separation process. The biological reactor zone is in the bottom region of the tank.

### BRIEF DESCRIPTION OF THE VIEW OF THE DRAWING

An exemplary embodiment of the invention will be further explained below with reference to a drawing.

The single FIGURE schematically illustrates a device according to the invention in the form of a circuit diagram.

An untreated water tank 10 is connected to a pressure tank 16 via a macerator 12 and a feed pump 14. The pressure tank 16 is connected to a compressed air source (not shown), and the compressed air is conducted through a line 18 into the tank 16. Pressure sensors 20 or respectively 22 are connected to the pressure tank 16, and a pressure of 5 to 6 bar is maintained in the pressure tank. A pressure sensor 24a closes a valve 26c and hence the supply of compressed air to the tank 16 when a predetermined pressure is reached. The pressure tank 16 is connected via a line 24 to a decompression tank 26 which will be further discussed below. A pressure release valve 26b controlled by the sensor 22 is arranged in the line 24. The pressure release valve reduces the pressure of the untreated water/air mixture in line 24 to atmospheric pressure. A reservoir 26a for flocculant is connected via a dosing pump 28 to the line 24.

On the inside, the decompression tank 26 preferably has a central, tubular outer container (outer pipe) 30 as well as an inner pipe 32 and a middle pipe 34 between the inner and outer pipe. The pipes 30 to 34 are communicating pipes and form ring channels between themselves, the inner pipe projecting above the outer pipe 30 at the top, and the middle pipe projecting above the inner pipe. The pipes 30 to 34 are coaxial and preferably cylindrical. At the height of the top end of the inner pipe 32, the inner pipe is surrounded by a conically descending surface 36 that forms a collection area 38 with the tank 26. This is connected to a collecting tank 40 for flotate. The middle pipe 34 is connected at the bottom end via a line 42 to a clarification water pump 44 that sends the clarification water through a UV irradiation device 46 and from there over board which is indicated by the line 48.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

The described device works as follows: Solids in the untreated water from the untreated water tank 10 are cut up in a macerator 12 (larger solids). The untreated water is conducted with the aid of the feed pump 14 into the pressure tank 16 where it is saturated with air (saturator). Such tanks are known in principle. The untreated water/air mixture is decompressed via the expansion valve 26b. In addition, flocculant is added within the line 24 (dosing pump 28). From there, it flows into the outer pipe 30 and rises therein as indicated by the dashed line. From the overflow at the top end of the outer pipe 30, clarification water flows back down into the bottom end of the inner pipe 32 while leaving flotate above the outer pipe 30. The clarification water flows over the top end of the inner pipe 32 downward into the gap between the inner pipe 30 and middle pipe 34 where it is removed with the help of the pump 44. The flotate floats above the outer pipe 30 and is pressed into it through the middle opening 51 of the conical floor of the flotate collection chamber 38. The overflowing flotate is represented as 50 in the FIGURE. Residual substances indicated as 52 with a dot-dashed line collect on the floor of the decompression tank 26 and can be conveyed via a sludge pump 54 into a sludge tank 56. The flotate from the flotate collection tank 40 is also conveyed therein. The sludge tank 56 is equipped with sensors 58 for measuring the level. The untreated water tank 10 is also equipped with level sensors 60 that control the pump 14. Only when the collecting tank 10 contains untreated water is the pump 14 is operated.

The tubular containers 30 to 34 form communicating pipes. Consequently, the height of the inner pipe 32 determines the level of liquid in the tank 26. The top end of the inner pipe 32 is at the same height as the opening 51 in the collection chamber 38. The middle pipe 34 projecting above the opening 51 ensures the flow into the middle pipe 34.

In the decompression tank 26, there are two ring mains 62 arranged one above the other at a distance. They are connected via a line 64 to a compressed air source (not shown). Air can bubble upward through openings in the ring mains 62 to remove the flotate by increasing the water level in the decompression tank 26 and lifting the flotate layer above the overflow in the collection area 38.

In the tank 26 below the bottom ring main 62, there is a fixed-bed reactor 49 for absorbing organic substances dissolved in clear water. The fixed-bed reactor 49 is not shown and is known in principle.

In the top area of the decompression tank 26, there is a spray nozzle arrangement 66 that is connected via a line 68 to a water pump 70 through which rinsing water is conducted into the decompression tank 26 for the purpose of cleaning. A line 72 branches from line 68 and runs to the line between macerator 12 and feed pump 14 to also accomplish cleaning in this manner.

This completes the description of the preferred and alternate embodiments of the invention. Those skilled in the art may recognize other equivalents to the specific embodiment described herein which equivalents are intended to be encompassed by the claims attached hereto

1. A device for clarifying wastewater, preferably on ships, comprising:
a tank (10) for untreated water is connected to a pressure tank (16) via a macerator (12) and a feed pump (14);
the pressure tank (16) is connected to a compressed air source (18) so that the untreated water in the pressure tank (16) is saturated with air;
the pressure tank (16) is connected via a line (24) to a decompression tank (26) in which the flotate and clarification water can be separated from each other;
an expansion valve (26b) is inserted in the line (24), and
a dosing pump (28) for flocculant is connected to the line (24) between the expansion valve (26b) and decompression tank (26).

2. The device according to claim 1, wherein an outer pipe (30) arranged in the decompression tank (26) ends in the line (24), an inner pipe (32) arranged in the outer pipe (30) and connected at the bottom end to the area between the decompression tank (26) an outer pipe (30) extends upward above the outer pipe (30), a middle pipe (34) between the inner and outer pipe extends upward above the inner pipe (32), an opening is arranged for flotate of a flotate collection chamber (38) above the top end of the outer pipe (30), and the middle pipe (34) is connected to a clarification water pump (44) in the bottom area.

3. The device according to claim 2, wherein a solids pump (54) is connected to the floor of the decompression tank (26) to convey solids to a sludge collection tank (56).

4. The device according to claim 2, wherein the relationship of the lengths to the diameters of the communicating pipes (30, 32, 34) is selected to ensure the separation of clarification water and flotate up to a slope of 22° to 23° in relation to the verticals.

5. The device according to claim 2, wherein the clarification water pump (44) can be controlled by the pressure in the feed line.

6. The device according to claim 1, wherein the feed pump (14) can be controlled by the amount of untreated water in the untreated water tank (10).

7. The device according to claim 1, wherein the clarification water flows through a UV irradiation device (46).

8. The device according to claim 1, wherein at least one ring main (62) connected to a compressed air source is arranged in the decompression tank (26), the ring main being provided with a series of openings.

9. The device according to claim 8, wherein two ring mains (62) are arranged at different heights in the decompression tank (26).

10. The device according to claim 2, wherein a conically sloping surface (36) is arranged below the top end of the middle pipe (34) and surrounds it and connects to an overflow for flotate and delimits the bottom of a flotate collection chamber (38).

11. The device according to claim 1, wherein all of the components of the device are arranged on a common base plate.

12. The device according to claim 1, wherein a fixed-bed reactor (49) is arranged in the bottom area of the decompression tank (26).
